(19) United States
(12) Patent Application Publication
(10) Pub. No.: US 2017/0282791 A1
(43) Pub. Date: Oct. 5, 2017

(54) Smart Seat

(71) Applicant: Jorja Voorhies, Kissimmee, FL (US)

(72) Inventor: Jorja Voorhies, Kissimmee, FL (US)

(21) Appl. No.: 15/084,063

(22) Filed: Mar. 29, 2016

(51) Int. Cl. B60Q 9/00; B60N 2/44; G08B 21/02; B60N 2/28

(52) U.S. Cl. CPC B60Q 9/00; B60N 2/28; B60N 2/44; G08B 21/0205; B60N 2002/4485

(57) ABSTRACT

An infant or toddler car seat is provided with smart technology to reduce or eliminate unattended child being left inside a vehicle. The car seat is programmed to alert pre-inserted contacts in addition to emergency services. The number of sensors combine together, to trigger an alert that an infant or child is left inside the car on seat as soon as an electronic device wirelessly connected to the central processing unit installed inside the vehicle.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to the field of infant or toddler safety alert systems that detect the presence of an unattended child inside a vehicle. The invention, particularly relates to a system and method remotely connected to an infant safety seat having sensing and notification abilities.

2. Description of Related Art Including Information Disclosed Under 37 CFR 1.97 and 37 CFR 1.98.

Every year there are scenarios wherein a child is injured or killed as a result of being left in an unattended vehicle, and generally from heat. In summer season, the temperatures inside a closed vehicle can reach 140 degrees or more, far too high for any person, especially a child to survive in for prolonged periods of time.

Some parents and caregivers, not wanting to go through the trouble of unbuckling and rebuckling an infant, will often leave the infant or infants in a vehicle while the person runs a quick errand such as running into the supermarket. Sometimes the infant or toddler is left for longer periods of time as the parent or caregiver goes to work with the infant in tow, or worse, goes to a nightclub or other adult oriented venue. Still other times the toddler is simply forgotten about as the parent or caregiver is running about town, especially if the caregiver is not the parent and is not accustomed to having children in the back seat on a regular basis.

There are a number of inventions that provide a generic means for notifying a person that an infant is left in a vehicle. Certain means of monitoring as well as the means for notification are associated with following:
a. Ignition state
b. Accelerometer
c. External motion
d. Door open/close
e. Child seat belt

Various sensors are associated with the above mentioned which either stop sensing or stop an indication that a child is left in a child seat.

A number of different types of infant safety alert systems and methods are available in prior art. For example, see: U.S. patent application Ser. No. 13/221,557 to Hoover et al.; 14/205,707 to Gregory; 14/284,004 to Rambadt et al.; U.S. Pat. Nos. 7,170,401 to Charles; 7,714,737 to James; 8,038,213 to Chelsea; 8,841,997 to Orlando.

U.S. Pat. No. 8,038,213 discloses a child safety seat system having sensing and notification abilities includes a child safety seat, a proximity sensor, a presence sensor, and a transmitter. The proximity sensor is configured to detect when a wireless receiver is located outside a predefined distance of the child safety seat.

Although most people will report an unattended child or toddler in a vehicle to police, many people do not pay attention to the insides of other peoples' vehicles in a parking lot and simply do not see an unattended child or infant. Window tinting and vehicles high off the ground oftentimes make detecting the presence of a child difficult, especially when the child is within a car seat and gives out no substantial silhouette against the vehicle's windows.

Hence, there is a need in the art to incorporate a child safety seat that has sensing and notification abilities, such that the caretaker or the parent or the like having responsibility of the child is alerted as soon as the child is left alone inside the vehicle.

### BRIEF SUMMARY OF THE INVENTION

In the view of the foregoing disadvantages inherent in the known types of child safety alert systems now present in the prior art, the present invention provides an improved child safety alert system. As such, the general purpose of the present invention, which will be described subsequently in greater detail, is to provide a new and improved child safety seat which has all the advantages of the prior art and none of the disadvantages.

An object of the invention is to provide an infant or toddler car seat with smart technology to reduce or eliminate unattended child being left inside a vehicle.

It is another object of the present invention to provide a car seat programmed to alert pre-inserted contacts in addition to emergency services.

It is another object of the present invention to provide a mobile application based network connected with a weight sensor.

It is another object of the present invention to provide the weight sensor that triggers an alert that an infant or child is left inside the car on seat as soon as mobile leaves the car.

It is another object of the present invention to provide a system and a method to eliminate the occurrence of an unattended child left behind in a vehicle by alerting or notifying a parent or caregiver.

It is another object of the present invention to provide a child surveillance system to monitor the activity of the child seated on the child safety seat.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a general sketch of a car including the system in accordance with the present invention.

FIG. 2 is a general perspective view of a smart seat.

FIG. 3 is a side elevational view of the smart seat of FIG. 2.

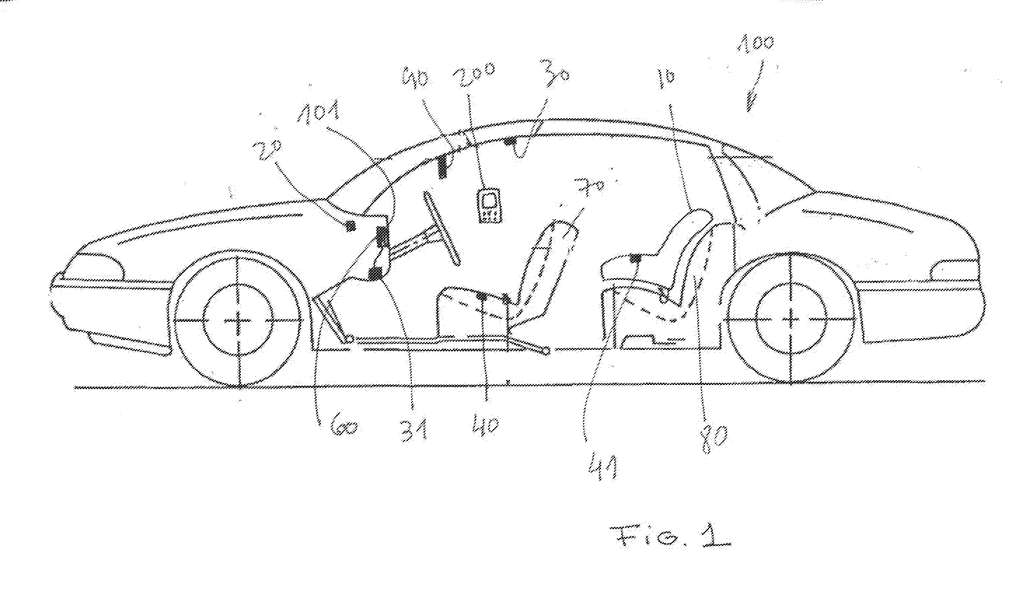

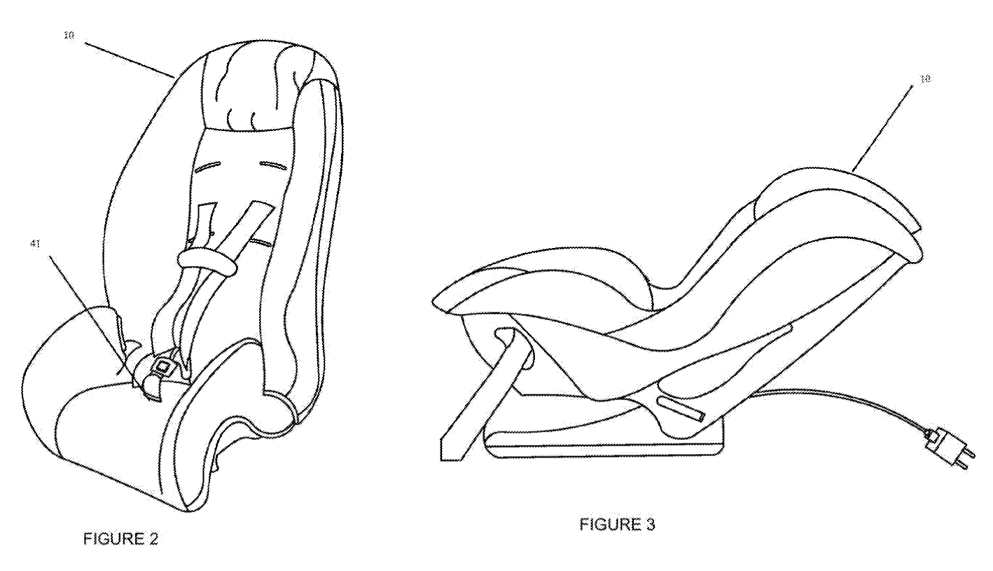

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides a system and a method primarily for eliminating or reducing the injury or death of an infant or a toddler left on a child safety seat 10 inside a vehicle 100. In addition to the above mentioned, the system and method of present invention also provides for a child video surveillance system and an audio/video playback system for amusement of a fussy child. The system of the prior arts, have utilized various combinations of sensors installed in the vehicle. In the preferred embodiment of the present invention the system utilizes the child safety seat 10 of the vehicle in a unique way in conjunction with a sensor mechanism. The sensor mechanism includes a proximity sensor 20, a temperature sensor (not illustrated), a couple of weight sensors 40-41 and a transmitter. All the sensors are located inside the vehicle 100 and wired to connect with a central processing unit 60 of the electronic system and powered by the battery of the vehicle. The central processing unit 60 is configured to the dashboard 101 of the vehicle, where it is easy to access. The temperature sensor 30 is also connected to a temperature control unit 31. The temperature control unit 31 is enabled to regulate the temperature inside the vehicle while doors and glasses are closed. The temperature control unit 31 maintains ambient conditions inside the vehicle. The temperature sensor 30 monitors the change in pre-set range of temperature. The temperature control unit 31 comprises a thermoelectric module and is connected to the central processing unit 60. One of the weight sensors (40) is installed underneath the driver's seat and the other weight sensor (41) is installed underneath the child safety seat. The weight sensors 40-41 monitor the occupancy of the respective seats 70-10.

The system of the present invention further includes an electronic device 200 that is wirelessly in contact with the central processing unit 60 already installed in the vehicle 100 over a network. The wireless network (not illustrated) can be any wireless data communication network for example Wi-Fi or Bluetooth or the like. The electronic device 200 used to communicate with the central processing 60 can be a handheld smartphone or a tablet or the like. A mobile application installed and running on the processor of the electronic device 200 is in contact with an already installed receiver in the electronic device 200. The receiver is capable of receiving any remote wireless signal by the transmitter of the central processing unit 60 of the vehicle 100.

The mobile application has pre-set emergency contacts that include ‘911’ installed as a cookie in the Readable-only-memory or ROM of the electronic device. These contacts are set by the user of the electronic device 200.

The proximity sensor 20 is configured to detect the location of the wireless receiver 200 inside or outside the vehicle 100. In another preferred embodiment of the present invention the system operates according to a pre-set of conditions to prevent child being left in the back seat or child safety seat 10. The pre-set of conditions are firstly locating the receiver 200 outside a predefined distance of the child safety seat 10, secondly detecting the absence of the driver in the driver's seat 70 by the first weight sensor 40 installed underneath it and thirdly detecting the presence of the child on the child safety seat 10 using the second weight sensor 41 installed underneath the seat 10. The information provided by the respective sensors 40-41 is processed by the central processing unit 60 and as soon as these conditions are fulfilled the processing unit enables transmitter to send out a wireless signal which is received by the receiver of the electronic device 200. The wireless signal so received by the mobile application running on the processor of the electronic device 200 and the application than sends out an alert to the pre-set emergency contacts. This alert is in the form of a digital communication. This digital communication can be in form of a short messaging service (SMS) text message or an email or a voice mail or the like. Hence, the driver of the vehicle or the user of the electronic device is alerted timely tender to the child left in the child safety seat.

In another embodiment (not illustrated), the video surveillance system for monitoring infant or child in the rear seat of the vehicle comprises a video camera placed within a child's toy. The camera is hidden from sight of the child or infant and installed on the backside of the seat beside the driver's seat or pillion seat. A semi-flexible means of mounting such as hinge mechanism or nut and bolt arrangement or the like is used to mount the camera on backside of pillion seat. The camera is electrically wired or connected to the central processing unit 60 in the vehicle 100. The camera is configured or adapted to firstly focus on the child seated on the child safety seat 10 and secondly to monitor the rearward seat 80 in the rearward compartment of the vehicle 100.

The surveillance system further comprises a video display monitor 90 situated and secured in an area within the view of a driver of the vehicle 100, the video display monitor 90 being linked remotely with the video camera via Bluetooth or Wi-Fi or Li-fi or the like, and electrically connected to the battery of the vehicle. The video signal by the camera is transmitted to the video monitor 90 by a video transmitter installed within the camera and the transmitted signal is received by a video signal receiver installed within the monitor 90. The video display monitor 90 is also electrically connected to the central processing unit 60 and comes with audio/video playback functionality.

The video camera is configured to transmit video images to the video display monitor. A rigid tubing which houses a video camera cable is provided, so that the camera can be directed to any desired location within the vehicle compartment in order to view the child. The video camera cable being a length of between 1 and 14 inches. The camera is fitted with night vision capable functionality and an illumination source such as one or more LED lights are also provided. The video camera cable being a length of between 1 and 12 inches. The display of the video monitor is touch enabled and is remotely linked to a smart phone or iPhone or iPod or the like by means of a Bluetooth connection. This enables the user or the driver to play music or a symphony or a video for amusement of the child or infant seated on the child safety seat of the present invention.

In yet another embodiment, the child safety seat or the smart safety may have a video display screen with attached small speakers (not illustrated). The video display screen comes along with a control unit and data communication capability like Bluetooth, Wi-Fi, Li-fi or the like. The assembly is encased in a rectangular casing made of carbon fiber, PVC, UPVC or the like just like a tablet or the smartphone or the like.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A system for use with a child safety seat of a vehicle, comprising:
a central processing unit configured to a dashboard of the vehicle;
a sensor mechanism connected to the central processing unit;
an electronic device wirelessly connected to the central processing unit over a network; and,
a video surveillance system.

2. The system for use with a child safety seat of a vehicle according to claim 1, wherein the sensor mechanism comprises a temperature sensor; a proximity sensor; a first weight sensor; a second weight sensor and a transmitter.

3. The system for use with a child safety seat of a vehicle according to claim 1, wherein the network used to wirelessly connect the electronic device with the central processing unit is Bluetooth or Wi-Fi.

4. The system for use with a child safety seat of a vehicle according to claim 2, wherein the temperature sensor is connected to a temperature control unit.

5. The system for use with a child safety seat of a vehicle according to claim 4, the temperature control unit comprises a thermoelectric module.

6. The system for use with a child safety seat of a vehicle according to claim 2, wherein the first weight sensor is configured to a driver seat.

7. The system for use with a child safety seat of a vehicle according to claim 2, wherein the second weight sensor is configured to the child safety seat.

8. The system for use with a child safety seat of a vehicle according to claim 5, wherein the temperature control unit is connected to the central processing unit.

9. The system for use with a child safety seat of a vehicle according to claim 1, wherein the electronic device is selected from a group comprising a smartphone, a tablet, a laptop, PDA.

10. The system for use with a child safety seat of a vehicle according to claim 9, wherein a wireless receiver is operably connected to a computer implemented means running on a processing unit of the electronic device.

11. The system for use with a child safety seat of a vehicle according to claim 10, wherein the proximity sensor is configured to detect when the wireless receiver is located outside a predefined distance of the child safety seat.

12. The system for use with a child safety seat of a vehicle according to claim 2, wherein the transmitter is configured to transmit a wireless signal to the wireless receiver.

13. The system for use with a child safety seat of a vehicle according to claim 12, wherein the wireless signal is transmitted when a pre-set of conditions are fulfilled.

14. The system for use with a child safety seat of a vehicle according to claim 13, wherein the pre-set of conditions are detection of absence of a first person on a driver seat by the first weight sensor; detection of presence of a second person in the child safety seat by the second weight sensor; and the wireless receiver located outside the predefined distance from the vehicle.

15. The system for use with a child safety seat of a vehicle according to claim 12, wherein the wireless signal is configured to cause the wireless receiver to generate an alert.

16. The system for use with a child safety seat of a vehicle according to claim 12, wherein the alert is a digital notification.

17. The system for use with a child safety seat of a vehicle according to claim 16, wherein the digital notification is also sent to a plurality of emergency contacts pre-stored in the computer implemented means.

18. The system for use with a child safety seat of a vehicle according to claim 17, wherein the computer implemented means is a mobile application.

19. The system for use with a child safety seat of a vehicle according to claim 1, wherein the central processing unit is powered by a battery installed in the vehicle.

20. The system for use with a child safety seat of a vehicle according to claim 1, wherein the child surveillance system is used to monitor the activity of a child seated on the child safety seat.

21. The system for use with a child safety seat of a vehicle according to claim 1, wherein the child surveillance system includes a video camera with a video signal transmitter and a video display monitor with a video signal receiver.

22. The system for use with a child safety seat of a vehicle according to claim 21, wherein the video camera is remotely connected to the video display monitor via Bluetooth.

23. The system for use with a child safety seat of a vehicle according to claim 21, wherein the video camera and the video display monitor are electrically connected with central processing unit of the vehicle.

24. The system for use with a child safety seat of a vehicle according to claim 21, wherein the video camera and the video display monitor are powered by the battery of the vehicle.

25. The system for use with a child safety seat of a vehicle according to claim 21, wherein the video display monitor comprises a touch sensitive screen and audio/video functionality.

26. The system for use with a child safety seat of a vehicle according to claim 22, wherein the video display monitor is remotely connected to the electronic device of a user in the driver seat.

27. A method for use with a child safety seat of a vehicle, comprising the steps of:
providing an electronic device wirelessly connected to a central processing unit via a network;
detecting when a wireless receiver is located outside a predefined distance of the child safety seat using a proximity sensor;
detecting a presence of a first person in a driver seat using a first weight sensor;
detecting a presence of a person in the child safety seat using a second weight sensor;
signaling the presence of the second person on the child safety seat to a transmitter;
signaling the absence of the first person on the driver seat to a transmitter;
transmitting a wireless signal to the wireless receiver using the transmitter when the first weight sensor detects absence of the first person on the driver seat, the second weight sensor detects the presence of the second on the child safety seat and the wireless receiver is located outside the predefined distance;
generating an alert via the wireless signal configured to the wireless receiver;
providing a video surveillance system with a video camera and a video display monitor.

28. The method of claim 27, wherein the central processing unit is configured to a dashboard of the vehicle.

29. The method of claim 27, wherein the temperature control unit comprises a thermoelectric module.

30. The method of claim 27, wherein the wireless signal is a digital notification.

31. The method of claim 27, wherein the wireless receiver is configured to a mobile application running on a control unit of the electronic device.

32. The method of claim 27, wherein the network is Bluetooth or Wi-Fi.

33. The method of claim 27, wherein the video surveillance system is used to monitor the activity of the child seated on the child safety seat.
